(19) United States
(12) Patent Application Publication
(10) Pub. No.: US 2009/0128364 A1
(43) Pub. Date: May 21, 2009

(54) Parking device

(76) Inventor: Wei-Chia Lee, Leonberg (DE)

Correspondence Address: KENYON & KENYON LLP, ONE BROADWAY, NEW YORK, NY, 10004, US

(21) Appl. No.: 11/988,499

(22) PCT Filed: May 29, 2006
(86) PCT No.: PCT/EP2006/062660

§ 371 Date: Jan. 14, 2009

(30) Foreign Application Priority Data
Jul. 8, 2005 (DE) 10 2005 032 095.3

(51) Int. Cl. G08G 1/123

(52) U.S. Cl. 340/932.2

(57) ABSTRACT

A parking device is for supporting a parking procedure, in which sensors record a vehicle environment and an evaluation unit ascertains an alignment of the parking space with the aid of the parking space environment.

### FIELD OF THE INVENTION

The present invention relates to a parking device.

### BACKGROUND INFORMATION

A method for ascertaining a suitable parking space is described in German Published Patent Application No. 102 58 310. In this particular instance, the side of the vehicle is picked automatically on which a parking space dimensioning is to be carried out for searching for a parking space suitable for parking. In this context, both the length of a suitable parking space is measured and the distance from the left-hand and the right-hand side is determined.

### SUMMARY

By contrast, the parking device according to example embodiments of the present invention may provide that the alignment of a parking space is automatically determined. By doing so, the effectiveness and the accuracy in the parking space measurement is able to be increased. For instance, a parking space for transverse parking perpendicular to the routing of the street is still able to be recognized as a suitable parking space, even when the distance between the parking space borders would not suffice for longitudinal parking. Furthermore, instructions and possibly support for longitudinal parking in two transverse parking spaces, which would also provide longitudinal parking, are also prevented. Overall, the reliability of parking space measurement is increased thereby, and the convenience to the user is raised. In addition, in the case in which the alignment of the parking space is already fixed, the accuracy of the parking space measurement may be increased by an adjustment of the measuring method used for the parking space measurement, for instance, with regard to reach.

The features described herein make possible advantageous developments of and improvements to the parking device. It is possible to determine the alignment of the parking space with the aid of vehicles in the surroundings of the parking space. If an orientation is inferred, in this instance, from the alignment of the vehicles already parked there, one may draw conclusions with high probability on the alignment of the parking space provided between the vehicles. By alignment one may understand, in this instance, any angular positioning of the vehicle that is to be parked in the parking space. In the most frequent cases, this will be either longitudinal parking in a parking space aligned in the travel direction, or angle parking approximately at right angles to the travel direction. However, it is also possible to have parking spaces aligned slantwise to the travel direction, for instance at an angle of approximately 45°, such an alignment also being measurable.

Furthermore, it is possible, in particular, to measure and evaluate the vehicle contour of a vehicle bordering on the parking space. From the alignment and the length of the contour it may be recognized whether the vehicle is standing with its longitudinal side parallel to the street, whether a front end or rear end points towards the street, or whether, in the case of a contour running possibly slantwise to the street, for instance, at an angle between 15° and 80°, the vehicle is parked slantwise to the street. With great probability, one's own vehicle should be parked in the same manner. Moreover, it is also possible to evaluate a scatter of the clearance values. By doing this, wheel wells are able to be recorded on a vehicle, so that, in such a case, one may draw conclusions on the alignment of the vehicle alongside the routing of the roadway. In order to ascertain which vehicle side is pointing to a passing vehicle, a memory is provided, for example, in which characteristic patterns are stored, for comparison with measured data.

It is also possible to provide an optical sensor for the detection of a lateral face of a vehicle. Thus, for example, sensors may be directed especially at recording a tire, by being designed to recognize a circular pattern in the vehicle's surroundings. One can thereby draw a conclusion on the outer surface of a tire and thus also on a position of the vehicle bordering the parking space aligned parallel to the routing of the street.

It is also possible to perform a curb detection. In order to supplement the ascertainment of positions of parked vehicles, it is possible to check whether a curb distance measurement coincides with the result of measuring the vehicle contours of the vehicles bordering on the parking space. By doing this, a greater predictive accuracy can be achieved.

Moreover, it is possible to determine a path into the parking space, according to the alignment of the parking space. In a corresponding fashion, control signals may also be emitted for parking in the parking space. The parking procedure itself may be carried out, either according to instruction by the parking device to the user or even automatically. In that case, the selection of a parking strategy by the driver can be omitted, since the alignment of the parking space is recorded automatically, and, that being the case, the path into the parking space is also established appropriately.

Exemplary embodiments of the present invention are illustrated in the drawings and explained in greater detail in the following description.

### BRIEF DESCRIPTION OF THE DRAWINGS

FIG. 1 is a schematic top view onto a motor vehicle having a parking device according to an example embodiment of the present invention,

FIG. 2 illustrates the method of functioning of a parking device according to an example embodiment of the present invention during measurement of the distance from a parked vehicle,

FIG. 3 illustrates two exemplary embodiments for possible reflection signals in the case of a parking space situated perpendicularly or slantwise to the routing of the street,

FIG. 4 illustrates an exemplary embodiment for measuring signals of a contour of vehicles bordering a parking space that are parked at a distance one behind the other, parallel to the travel direction,

FIG. 5 illustrates a method according to an example embodiments of the present invention for operating the parking device.

### DETAILED DESCRIPTION

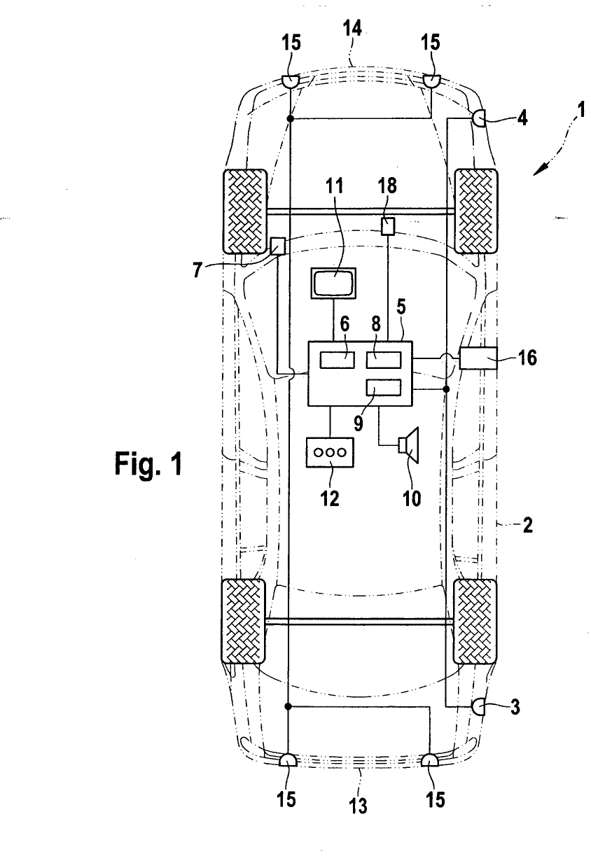

FIG. 1 shows a motor vehicle 1 at whose right vehicle side 2 a first distance sensor 3 is situated in the rear region of the vehicle and a second distance sensor 4 is situated in the front region of the vehicle. In an example embodiment, distance sensors 3, 4 are executed as ultrasound distance sensors. An ultrasound signal emitted by these sensors is reflected by obstacles in the region of the right vehicle side, and is picked up again by distance sensors 3, 4. Correspondingly received signals are passed on to an evaluation unit 5 in the vehicle. Taking into account the speed of sound, a computing unit 6 calculates a distance from the obstacles in the vehicle's surroundings. Instead of the ultrasound sensors, other environment recording sensors, for instance, radar sensors, lidar sensors or video sensors may be used to conduct the distance measurement.

In order to be able to ascertain a corresponding course of a contour of obstacles in the surroundings of the right vehicle side, the measured distance values are in each case assigned to a position of the vehicle. For this purpose, evaluation unit 5 is connected to a wheel sensor 7 and preferably also to a steering angle sensor 18. A length of travel that has been covered by the vehicle is able to be measured via wheel sensor 7. In addition, the steering angle of the steering system may be ascertained via the steering angle sensor. By the combination of covered length of travel and the steering angle, the travel path of the vehicle may be traced back. The distance values measured by distance sensors 3, 4 are stored in a, e.g., nonvolatile memory 8 in evaluation unit 5. They are assigned to a position on the travel route of the vehicle, in the storage process.

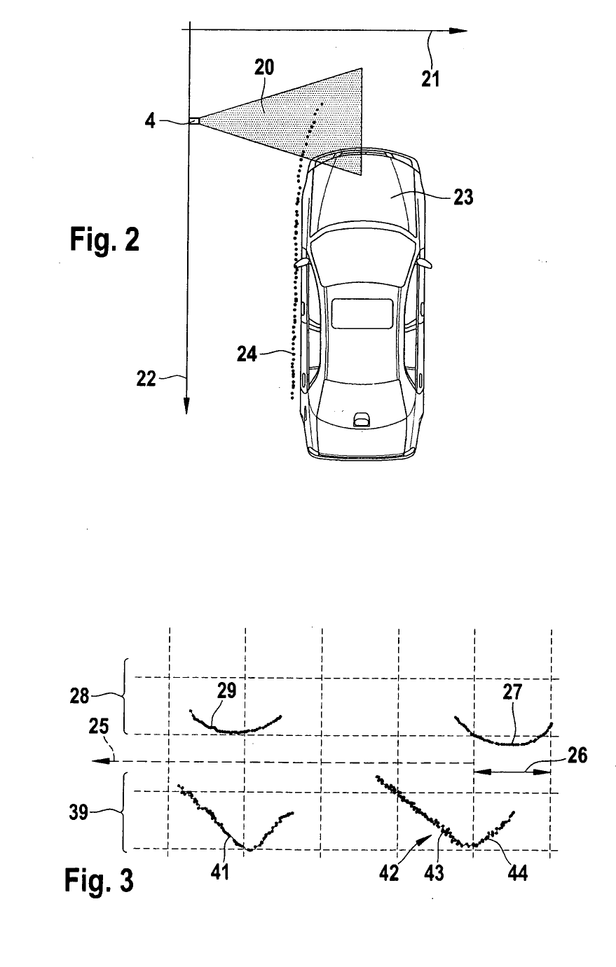

The carrying out of a measurement is shown in FIG. 2. For simplicity's sake, only distance sensors 4 of vehicle 1 in the front region of the vehicle is shown. When it is executed as an ultrasound sensor, distance sensor 4 emits a sonic lobe 20. While driving past, the reflected sonic signals, which lead one to form a conclusion on the position of an obstacle, can be assigned spatially in relationship to the motion of the vehicle by the assignment via the length of route covered and, if necessary, the steering angle. An x coordinate 21 and a y coordinate 22 may be assigned correspondingly to a reflected signal, the travel plane of the vehicle being selected as that plane in which the coordinate system is generated. Correspondingly, while driving past a parked vehicle 23, one obtains a set of measuring points 24, from which one can draw conclusions as to the contour of parked vehicle 23. A front distance sensor 4 on the vehicle is sufficient, in this instance, for the measurement of a parking space. In the case in which, possibly, a parking space is also to be measured during driving past in reverse, distance sensor 3 may be provided as a supplementary measure. If necessary, however, the second distance sensor may also be used for a redundancy measurement or a control measurement. Moreover, it is also possible to use still further sensors for distance measurement. In the exemplary embodiment shown in FIG. 2, a rather great length of an obstacle in the form of a vehicle is measured according to measuring points 24. The measured length of obstacle 23 can be compared with stored values in a memory 9 of the evaluation unit. Thus, it is possible, for example, that obstacles having a smooth surface and a length between 2.5 and 5 m are regarded as being parked vehicles aligned parallel to the street routing, that is, along y axis 22. Thus, parked vehicle 23 shown in FIG. 2 is aligned parallel to the travel direction of the traveling vehicle that is to be parked.

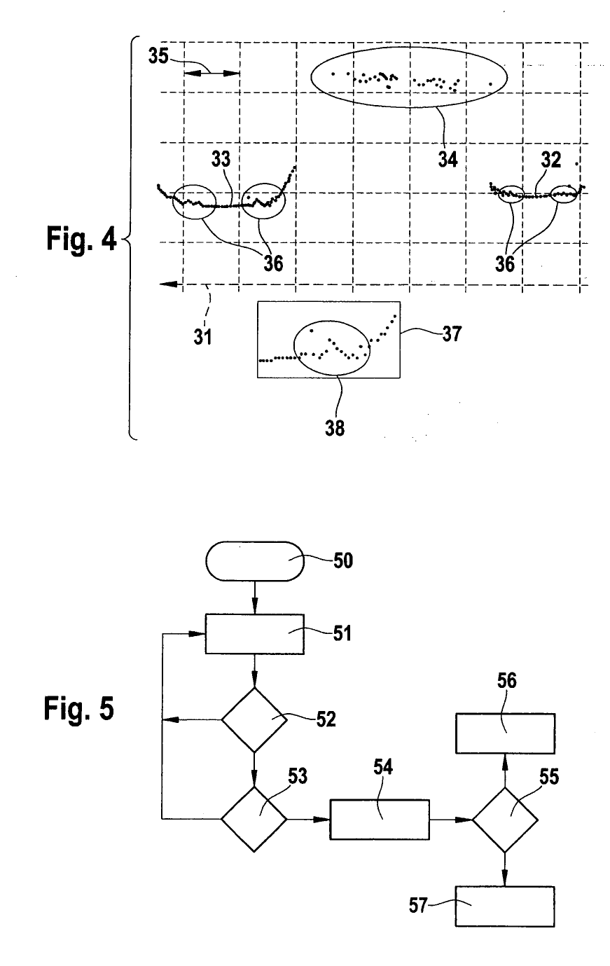

In order to check whether there is a vehicle situated parallel to the routing of the street, an additional evaluation is shown in FIG. 4, only the measuring results being entered on a diagram, but not the appertaining vehicles. In accordance with arrow 31, a vehicle has traveled past various obstacles. In doing so, a first contour 32, a second contour 33 and a third contour 34 were recorded. The width of a little box according to that shown by double arrow 35 is supposed to represent a clearance of 2 m. First signal 32 and second signal 33 are about a signal reflected by a parked vehicle, which makes possible a correspondingly good reflection, and in which a length of the vehicle of about 3.50 m to 4.50 m is recorded. As a result, a vehicle aligned in the travel direction 31 could be involved. This is also confirmed by scattering 36 in the beginning and ending regions of the obstacle. In supplementary illustration 37, the region of scattering 36 is shown enlarged. Because of the wheel well on the vehicles, the pattern of signals 32 and 33 is interrupted by an interference 38, in a short range. This is caused in that the measuring beam is able to penetrate into the wheel well, and, because of this, there appears to be a greater clearance over a small range. With the aid of this scattering, it may also be detected or at least confirmed that, in this case, a vehicle is involved that is aligned in travel direction 31. This means that longitudinal parking parallel to the travel direction is to be performed. Accordingly, it can be checked whether the distance between the vehicle assigned to first signal 32 and the vehicle assigned to second signal 33 is sufficiently large for the parking of the vehicle itself. For this it is necessary that evaluation unit 5 carry out a comparison of the parking space length to a length of the vehicle to be parked, that is stored in memory 9. An additional checking is possible by an evaluation of additional signal group 34. In this instance, the greater scattering permits one to conclude that a curb is involved, in response to which only a scattered reflection takes place, because of its low height. The distance of the curb may also be evaluated along with the rest as a plausibility check. If the distance is very great, there may possibly be present a transverse parking space. In the present case, the distance between a front vehicle edge and the curb amounts to hardly 4 m. This would certainly be sufficient for longitudinal parking, but would possibly be too tight for a transverse parking space.

Other exemplary embodiments for measuring data are shown in FIG. 3. The two illustrations 28, 39 of signals in FIG. 3 are intended to describe different signal recording situations which occur spatially independent of one another. Double arrow 26 in FIG. 3 is intended to designate a distance of 2 m. In a first illustration 28, a first signal 29 is shown of a first obstacle, and a second signal 27 of a second obstacle, having a length of about 2 m in each case, and a distance of about 4 m. For a longitudinal side of a vehicle, both signals 27 and 29 are too short. That being the case, the detected obstacles are probably a front end of a vehicle or a rear end of a vehicle. Thus, the vehicles are positioned perpendicular to a travel direction sketched in as a dashed line. The vehicle can possibly also be parked at right angles to travel direction 25 in the parking space between vehicles 27 and 29, if, in addition, no further obstacle signals are recorded in the clearance between the two signals 27, 29, and the distance between the two vehicles is sufficient for transverse parking.

Second illustration 39 shows a first signal 41 and a second signal 42 adjacently. The two signals lead one to conclude that an obstacle is pointing towards the passing vehicle in a pointed manner. It is noticeable, here, that, for instance, in the case of second signal 42, a first side surface 43 is longer than a second side surface 44, which are approximately perpendicular to each other. One may conclude from this that the vehicles assigned to signals 41, 42 are situated slantwise to the routing of the travel direction of the vehicle. From the angle of the routing of signals 41, 42 one may conclude the angle of incidence of the vehicle that is to be performed, compared to the travel direction.

When computer unit 6 has ascertained a suitable parking space and its alignment, it gives out a notice to the driver, for instance, via the loudspeaker or display 11. In case of doubt, the driver is able to correct the ascertained alignment of the recorded parking space, via a control unit 12. Furthermore, the user is able to begin the parking procedure by, for instance, either an implicit driving action. In a first specific embodiment, evaluation unit 5 automatically controls the drive train of vehicle 1 in such a way that the vehicle is parked from its current position into the measured parking space, along one of the parking trajectories calculated by computer unit 6. In an example embodiment it is also possible that the driver is given steering directions via display 11 and/or loudspeaker 10 such that, by following these steering instructions, he is able to park the vehicle from its current position into the parking space independently. Additional distance sensors 15 are preferably situated especially at a vehicle rear end 13 and/or at a vehicle front end 14 for support during the parking procedure, which measure the distance from obstacles in front of and/or behind the vehicle. Hereby, the driver can also be warned of obstacles during the parking procedure. During the parking procedure, a correction of the measured parking space length may also be made, and the travel path into the parking space may be automatically corrected.

In an example embodiment, evaluation unit 5 may also have a camera unit 16 connected to it, which observes the vehicle's surroundings in the region of vehicle side 2. In particular, the camera is situated, in this case, such that it is led past the parked vehicles, when one is driving by, and it is able to observe them. In this context, evaluation unit 5 is designed for an image analysis of image data generated by camera 16 that preferably works in the infrared range. In this process, vehicle contours may be ascertained and, in particular, compared to patterns of vehicle contours stored in memory 9. In particular, it is possible to carry out a circular pattern detection for detecting wheels. If the camera is able to detect wheels on the vehicle, it may be concluded from this that the parked vehicle is aligned approximately parallel to the travel direction of vehicle 1.

FIG. 5 shows a method sequence according to an example embodiment of the present invention. The method begins with an initialization step 50, and is triggered, for instance, by a driver using an activation of a parking space measurement. In a plotting step 51, while driving past, a curve of the contour of obstacles is plotted on vehicle side 2. In a first checking step 52, it is checked whether a parking space is being recorded on right vehicle side 2. If this is not the case, the system branches back to plotting step 51 and the plotting of a contour of obstacles on right vehicle side 2 is continued. If a parking space is ascertained, the system branches to a second checking step 53. In second checking step 53 it is checked whether an ascertained parking space is big enough for longitudinal parking or transverse parking. If no suitable parking space is found, the system also branches back to plotting step 51, and the plotting procedure is continued. If, on the other hand, a suitable parking space is found, the system branches forward to a valuation step 54. In valuation step 54, the alignment of the parking space is determined by an analysis of the parking space measurement, as was explained above in exemplary fashion. To do this, in particular, a length comparison of contours of obstacles that border on the parking space may be carried out. Furthermore, a scattering of the measuring signals may also be investigated, from which one may conclude the mounting of wheel wells. It is also possible to carry out an image analysis of vehicles recorded via a video sensor. In a subsequent third checking step 55 it is checked whether the parking space is a longitudinal parking space or a transverse parking space. If a longitudinal parking space is involved which is situated parallel to the travel routing of the vehicle, the system branches to a longitudinal parking step 56. Besides checking for the length of the parking space, the system also checks whether the width is sufficient for vehicle 1. Upon user request, the vehicle is parked in the longitudinal parking space, starting from its current position and going backwards parallel to its present travel direction. If, however, it is determined in the third checking step that a transverse parking space is involved, in which one will have to park approximately perpendicular to the present travel direction, a correspondingly different parking path has to be calculated. To do this, the program branches to a transverse parking step 57. The vehicle is conducted, preferably starting backwards, from its current position, by a correspondingly sharp steering angle, into the recorded transverse parking space. In particular, one should pay attention to possible clearances from obstacles within the parking space.

In an example embodiment, corresponding parking procedures may also be performed, corresponding to a recorded alignment, at any angle desired, to the current direction of travel.

Besides the search for a parking space, explained with the aid of exemplary embodiments, on the right side of the vehicle, the left side of the vehicle may equally well be monitored for parking on this side, especially for use on parking lots, on one-way streets or in road networks in which left-hand drive is used.

1-10. (canceled)

11. A parking device for supporting a parking procedure of a vehicle, comprising:
sensors configured to record a vehicle environment on at least one side of the vehicle; and
an evaluation unit configured to ascertain an alignment of a parking space in accordance with a recording of a parking space environment.

12. The parking device according to claim 11, wherein the evaluation unit is configured to ascertain: an alignment of vehicles in the parking space environment; an alignment of at least one vehicle in the parking space environment; and an alignment of at least one vehicle assigned to the parking space.

13. The parking device according to claim 12, wherein in the case of a vehicle in the vehicle environment that is parked approximately perpendicular to a direction of travel of the vehicle, a conclusion is drawn that there is a transverse parking space, and in the case of a vehicle in the vehicle environment that is parked approximately parallel to the parking space, a conclusion is drawn that there is a longitudinal parking space.

14. The parking device according to claim 12, further comprising distance sensors configured to measure a vehicle contour of a vehicle located next to the vehicle, that borders on the parking space, to ascertain the alignment of the vehicle.

15. The parking device according to claim 14, further comprising a memory configured to store characteristic patterns for at least one of (a) a front end of a vehicle, (b) a rear end of a vehicle and (c) a longitudinal side of a vehicle for ascertaining the alignment of a vehicle.

16. The parking device according to claim 12, further comprising an optical sensor configured to detect a side surface of vehicle wheels.

17. The parking device according to claim 11, further comprising distance sensors configured to detect a course of a curb in a region of the parking space.

18. The parking device according to claim 11, further comprising a computer unit configured to calculate a parking path into the parking space according to the recorded alignment of the parking space.

19. A method for parking support, comprising:
measuring a parking space at a side of a vehicle when the vehicle is driving by the parking space; and
proposing at least one of (a) a longitudinal parking and (b) a transverse parking in the parking space as a function of a measurement of an environment of the parking space.

20. The method according to claim 19, further comprising:
ascertaining an alignment of at least one vehicle in the environment of the parking space; and
selecting an alignment of the parking space corresponding to the alignment of the at least one vehicle.
